(19) United States
(12) Patent Application Publication
(10) Pub. No.: US 2006/0013579 A1
(43) Pub. Date: Jan. 19, 2006

(54) Self-generated content with enhanced location information

(75) Inventors: Godert W. R. Leibbrandt, Eindhoven (NL); Wilhelmus J Van Gestel, Heeze (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/538,209

(22) PCT Filed: Dec. 8, 2003
(86) PCT No.: PCT/IB03/05748

§ 371 Date: Jun. 9, 2005

Related U.S. Application Data
(60) Provisional application No. 60/432,535, filed on Dec. 11, 2002.

(51) Int. Cl. G03B 17/24

(52) U.S. Cl. 396/310

(57) ABSTRACT

A system and device for acquiring self-generated content and determining additional data related to the self-generated content. The content acquiring device (120) may have a content input, a data input (110), and a processor (122). The data input (110) acquires content, a time of acquiring the content and/or a location of acquiring the content. The data input (110) receives at least one of timeframe data and reference location data. The processor (122) is operatively coupled to the content input and the data input (110) and is utilized to determine additional data from a relation between at least one of the time of acquiring the content and the location of acquiring the content, and at least one of the timeframe data and the reference location data.

The present invention generally relates to a method and system for providing additional information for self-generated content, such as audio and visual content, and particularly relates to a method and system for providing the self-generated content with additional data such as enhanced location information.

There are systems that store self-generated content, such as self-generated image content from a camera, with additional data regarding a time and location of when and where the image content was acquired. For example, cameras, such as camcorders and digital cameras, are known that maintain a current time indication. These cameras have the ability to store the time indication, at the time of image acquisition, together with the digital image data. Other cameras are known that utilize a global positioning system (GPS) location indication, typically simple GPS coordinates, for purposes of storing the GPS coordinates that indicate a location of image acquisition together with the image data.

However, problems exist in that the GPS coordinates in many cases yields insufficient information to be useful or even meaningful to a user. Namely, the GPS coordinates must first be resolved into coordinates carrying more meaning, like a town or region where the image was acquired. This additional information in many instances may still not prove to be sufficiently informative since in many instances, where a picture was acquired may later carry little meaning to the user. For example, during vacations many pictures are acquired on day trips. A typical day trip may consist of starting at a town A and traveling to a town B, then to a town C, and thereafter, at the end of the day, traveling to a town D. The information that an image was acquired at a location X carries far less meaning then, for example, the information that the image was acquired somewhere on the road from town B to town C. In addition, in prior systems, location information stored with the image data is determined and stored solely at the time of image acquisition. Oftentimes, it may not be till sometime after an image is acquired that relevant location information is determined.

Accordingly, it is an object of the present invention to overcome the above disadvantages and other disadvantages of the prior art.

The invention provides a system, such as a camera system, for acquiring self-generated content and determining additional data related to the self-generated content. In accordance with one embodiment, the content acquiring device may have a content input, a data input, and a processor. The data input may be utilized for acquiring content, as well as for acquiring a time of acquiring the content and/or a location of acquiring the content. The data input receives at least one of timeframe data and reference location data. The processor is operatively coupled to the content input and the data input and is utilized to determine additional data from a relation between at least one of the time of acquiring the content and the location of acquiring the content, and at least one of the timeframe data and the reference location data.

The content acquiring device may be an imaging camera such as a photographic camera, a motion picture camera, or a camcorder. The content acquiring device may include a global position system receiver (GPS) coupled to the processor for providing the processor with the location of acquiring the content. The content acquiring device may use both the timeframe data and the reference location data for determining the additional data. The timeframe data may be a start and an end of a time interval. The reference location data may be a location of the content acquiring device at the start and the end of the time interval.

The content acquiring device may also include a memory for storing the acquired content and the determined additional data. Further, the data input of the content acquiring device may be a microphone for receiving audio input that is converted by the processor to the timeframe data and/or the reference location data. The data input of the content acquiring device may also be connectable to an external network, such as the World Wide Web (WWW), or an external data source, such as a computer or an external storage device.

The following are descriptions of embodiments of the present invention that when taken in conjunction with the following drawings will demonstrate the above noted features and advantages, as well as further ones. It should be expressly understood that the drawings and description are included for illustrative purposes and do not represent the scope of a present invention. The invention is best understood in conjunction with the accompanying drawings in which:

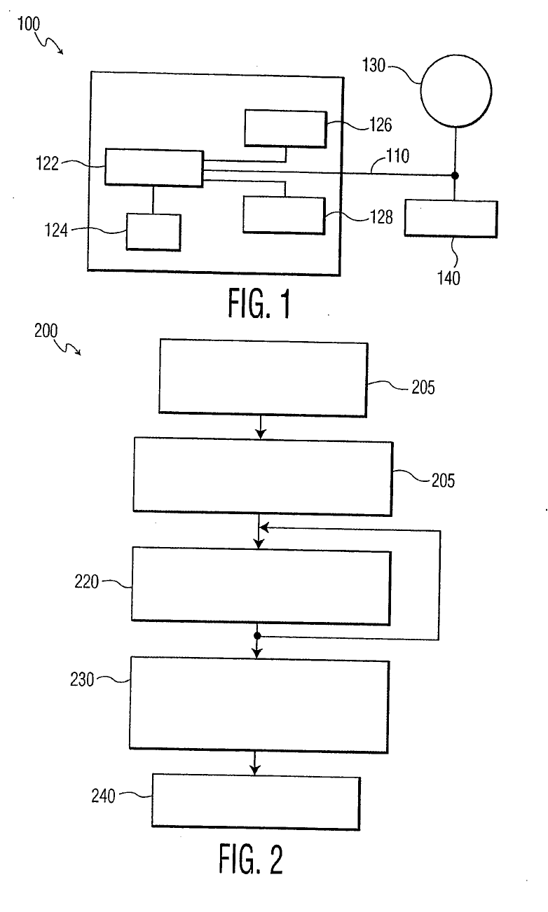

FIG. 1 shows an illustrative embodiment of a system in accordance with an embodiment of the present invention;

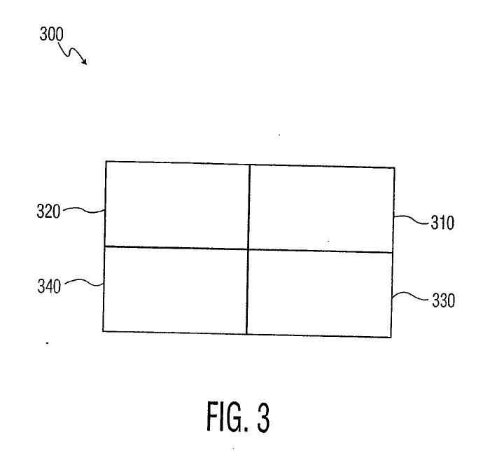

FIG. 2 shows a flow diagram illustrating operation of a system in accordance with an embodiment of the present invention; and

FIG. 3 shows a portion 300 of the memory 126, for storing data related to an image that is acquired in accordance with the present invention.

FIG. 1 shows an illustrative system 100 in accordance with an embodiment of the present invention including a content acquisition device, hereinafter generally referred to as a camera 120, having a content acquisition device, such as an imaging system (not shown). The content acquisition device is operatively coupled to a processor 122. The operation of a content acquisition device for acquiring content, such as an imaging system of a digital camera for acquiring digital image content, is known in the art and will not be discussed further herein accept as may be necessary to further discuss the inventive aspects of the present invention. To facilitate operation in accordance with an embodiment of the present invention, the processor 122 may be operatively coupled to a memory 126, an audio input, such as microphone 128, and a coordinate resolving device, such as a GPS receiver 124. It should be noted that each of these elements also might operate in accordance with known imaging systems. For example, the memory 126 may be utilized to store imaging content acquired by the camera 120 and resolved by the processor 122 as is known in the art.

In accordance with an embodiment of the present invention, the camera 120 may also have a data input 110. The data input 110 is illustratively shown coupled to an Internet connection 130 for operatively coupling the camera 120 to data servers via the World Wide Web (WWW . . . ). The data input 110 is also shown coupled to a local data source, illustratively shown as a computer 140. It should be noted that the scope of the present invention is not intended to be limited to the illustrative data sources shown in FIG. 1, since any data source may suffice for operation in accordance with the present invention. For example, the data source could readily be any data source such as an optical storage device, a fixed disk storage device, a solid-state storage device, etc.

Further, the data input 110 should be understood to accommodate any means for operatively coupling the camera 120 with a data source. For example, the data input 110 may include an Ethernet interface for coupling to a data source through either a wired or wireless Ethernet connection. Other means of coupling are also known such as a Universal Serial Bus (USB) coupling, a wireless 802.11 coupling, a BlueTooth coupling, a Wi-Fi (Wireless Fidelity) coupling, etc. Any of these or other coupling systems may be suitably utilized in accordance with the present invention. The data input should also be understood to encompass local removable storage media, such as Compact Flash media, Secure Digital Multimedia Cards, etc.

In accordance with an embodiment of the present invention, the camera 120 may also capture and/or determine additional data through the use of at least one of the data input 110, the memory 126, the mike 128, and/or the GPS receiver 124. The additional data is stored at some time in the memory 126 in a memory location associated with acquired image data. The additional data is above and beyond the raw GPS coordinate data supplied by the GPS receiver 124. The additional data is intended to provide a user with, for example, enhanced location information that is meaningful in assisting the user to recall details of where image data is acquired. This additional data is then retrieved by the user together with the image data at some later time to, for example, act as a recall aid so that the user may later recall the significance of acquired image data.

Further operation of the present invention will be described herein with regard to the illustrative system 100, shown in FIG. 1, and with regard to FIG. 2 that shows a flow diagram 200 in accordance with an embodiment of the present invention.

As illustrated, during act 205 timeframe and/or reference location data, illustratively related to GPS coordinate data is received by the camera 120. The timeframe and/or reference location data may be stored in a portion of the memory 126 for later use by the processor 122. In an embodiment where the data input 110 accommodates a local storage media, the timeframe and/or reference location data may be received from the local storage media. In the same or a further embodiment, the camera 120 may receive timeframe and/or reference location data from the Internet 130, the computer 140, and/or any other external data storage device.

In accordance with an embodiment of the present invention, the timeframe and/or reference location data may be utilized by the camera 120 to provide a user with meaningful information (e.g., criteria) related to a GPS coordinate wherein content, such as an image, was acquired by the camera 120. For example, the reference location data may correspond to a town and/or city having a significant population density, such as a city having a population density over 100,000 people. It should be noted that population density equal to or greater than any number may, in some embodiments, not be the criteria utilized to determine what is significant criteria to a given user. However, a location with a large population density (e.g., >100,000 people) may be more likely to be significant criteria to a user than a location with a small population density.

Other criteria that may be significant criteria to a user may include, for example, the place of birth of the user or other people known to the user. Significant criteria may also be a residence of the user or other people known to the user. Other characteristics of a location that may render that location as significant criteria to a user would be readily apparent to a person of ordinary skill in the art and may also be criteria utilized in accordance with the present invention. Accordingly, any of these other criteria should be understood to be within the scope of the present invention.

In an embodiment wherein the criteria includes personal information of a user, the data input 110 may be a computer mouse input, a keyboard input, or other known input particularly suited to facilitate the user directly inputting the personal information. In accordance with the present invention, the processor 122 may have the ability to determine reference location data corresponding to, or in close proximity with GPS coordinate data determined from the GPS receiver 124 or determined from another source of coordinate data coupled through the data input 110. The timeframe and/or reference location data may also be utilized to identify other significant characteristics, such as criteria related to image acquisition as described further herein below.

During act 210, the camera 120 acquires an image. Additionally, the processor 122 may receive time of image acquisition data and GPS coordinate data, from the GPS receiver 124. The GPS coordinate data may identify the location of where the image was acquired. During act 220, the processor 122 stores the GPS coordinate data, time of image acquisition data, and image data, corresponding to the acquired image, in the memory 126. It should be noted that the processor 122 may be utilized as a time keeping device to determine the time of image acquisition data or a separate time keeping device, such as the GPS receiver 124, or other not shown, may be contained within the camera 120 for determining the time of image acquisition data. The processor 122, utilizing a time keeping device, captures the current time at the time of image acquisition to determine the time of image acquisition data.

FIG. 3 shows a portion 300 of the memory 126, for storing data related to an image that is acquired in accordance with the present invention. As shown, the portion 300 comprises a portion 310 for storing image data, a portion 320 for storing the GPS coordinate data, a portion 330 for storing the time of image acquisition data, and a portion 340 for storing additional data. The additional data will be described further herein below. In accordance with the present invention, the act 220 may be repeated one or more times thereafter and any additional data acquired will be similarly stored in the memory 126 resulting in additional memory portions 300.

During act 230, the processor 122 queries the one or more memory portions 300 for the GPS coordinate data and/or the time of image acquisition data corresponding to the image data acquired during act or acts 220. Utilizing the timeframe and/or reference location data, additional data corresponding to criteria, such as characteristics of particular interest, are determined by the processor 122 and are stored in the portion or portions 340 for each of the images acquired.

For example, in one embodiment, the timeframe data may relate to an interval of time, such as a one-day interval. In accordance with one embodiment of the present invention, the processor 122 determines reference location data at a beginning and end of the one-day interval. The reference location data may correspond to where the camera 120 is located, or located close to (e.g., a location with a high population density), at the beginning and end of the one-day interval. In this embodiment, after determining where the camera 120 is located at the beginning and end of one or more one-day intervals, the processor 122 queries the one or more memory portions 330 to identify images acquired during each of the one or more one-day intervals. When an image is identified that was acquired during a given one-day interval, the corresponding locations of the camera 120 at the beginning and end of the one-day interval are stored in the portion 340 as the additional data for that image. In this way, when the processor 122 is utilized to retrieve the data stored in image portion 300 during act 240, the additional data stored in the portion 340 is also retrieved. Inventively, this system 100 enables a user to retrieve the additional data for each acquired image that oftentimes may be more significant criteria to the user then merely the location where the image was acquired.

Oftentimes, images are acquired when the user is traveling throughout the course of the day. A given location where an image is acquired may be no more than some interesting stop along the way. However, sometime thereafter, it may be difficult to determine how each of the acquired images relates to a past event or trip. The present invention solves this problem by determining additional data for each acquired image. The additional data relates to criteria other than just the time and location of image acquisition and thereby may provide the user with further cues to help remember the significance of each acquired image.

For example, for a user taking a day trip from New York City to Niagara Falls, the user may stop at a lake along the way that is an appealing spot to acquire an image. The exact location of the spot may have no significance to the user. However, the additional data that the spot is located between New York City and Niagara Falls (e.g., the beginning and end location of the camera 120 during a given one-day interval) may be fundamental criteria in aiding the user to recall how the acquired image relates to the user. After all, oftentimes it is not just the composition of the acquired image that is significant to the user. An acquired image may only be significant to the user if the user has the ability to recall how the acquired image relates to the user. Yet, many times a user does not have this ability utilizing prior art image acquisition systems because the image itself, and even additional data such as time of image acquisition and location of image acquisition, is not significant to the user sometime after image acquisition. In this embodiment, it should be clear that the data input 110 need not be separate from the processor 122, the memory 126, and/or the GPS receiver 124 since the timeframe and/or reference location data may be derived from each or either of these devices.

Inventively, the present system provides the user with additional data that assists the user in determining the significance of acquired images. The additional data, determined from the received timeframe and/or location coordinate data, is stored with the acquired image data and is retrieved by the user, when the image data is retrieved.

As another example, image data may be acquired over the course of a one or more day trip while traveling from the users place of residence to a user's parent's place of residence. Again, the significance of the image data may be its relation to the trip itself, as opposed to the location of where the image data was acquired. In this case, some of the additional data may be the location at which the trip started and the locations significance to the user. This data may be determined at the beginning of the trip via the GPS receiver 124.

Further, the additional data may be determined from other sources such as the mike 128. In this embodiment, the processor 122 may receive audio input from the mike 128 and thereafter, may convert the audio input to speech via speech recognition. The recognized speech may then be utilized to determine reference location data utilized in accordance with the present invention. For example, the user may activate the mike 128 to capture speech from the user stating, “I am on my way to my mom's house.” This speech is analyzed by the processor 122 to determine reference location data that indicates the significance of any images acquired during the trip to mom's house. Thereafter, the GPS coordinate data of images that are acquired is analyzed to determine if the images are acquired along this route (e.g., on the way to mom's house). When the images are acquired along this route, the additional data stored along with the images is data identifying that the images were acquired on the way to mom's house.

The images may be acquired before or after the reference location data is provided to the camera 120. For example, when the reference location data is a beginning and ending location, the images may be acquired prior to the processor 122 determining the ending location. The processor 122 may store the beginning location with the acquired images and may at some time later, store the ending location with the same acquired images. Additional criteria for identifying significant locations (e.g., locations with a high population density or tourist attractions) may not be determined till some time later after the camera 120 is connected to a data source via the data input 110. In any event, whenever the camera 120 acquires other related data, such as reference location data, the processor 122 may store this related data as additional data with the associated acquired images.

The processor 122 may also utilize logic for identifying other additional data. For example, the processor 122 may utilize the speech data “I am on my way to my mom's house” to determine additional data for images acquired around mom's house, in a given time frame (e.g., around the time frame of the trip). The additional data may be “the images where acquired during the trip to mom's house from this date (e.g., a start date) to that date (e.g., an end date).”

In another embodiment, the processor 122 may determine a location of the camera at the end of a day, and thereafter determine if the location at a following day is the same, thereby indicating a stop over location. The indication of a location that is a stop over location may also be thereafter stored as additional data in the memory portion 340 for images that are acquired in a time or location proximity to the stop over location.

In yet another embodiment, a device in accordance with the present invention may operate to generate a trip description. During the trip, the time of image acquisition and the location of image acquisition is stored. During or after the trip, the location of image acquisition may be translated to a more understandable description like road numbers, towns, etc., and saved as the additional data. In this way, the acquired images taken along a given route may be stored, with the given route saved as the additional data.

It should be understood by a person of ordinary skill in the art that the sequence of acts shown in FIG. 2 is not intended as a limitation to the appended claims. Specifically, any other sequence of the illustrated acts may be constructed that still would operate in accordance with the present invention. For example, in one embodiment, all the image data including time of image acquisition and/or location of image acquisition may be acquired prior to the camera 120 receiving any timeframe data and/or reference location data. Further, even the timeframe data may be received at a later time or from a separate source than the reference location data.

Finally, the above-discussion is intended to be merely illustrative of the present invention and should not be construed as limiting the appended claims to any particular embodiment or group of embodiments. For example, other criteria would readily occur to a person of ordinary skill in the art and should be construed to be within the scope of the present invention. Further, multiple criteria may be stored for one or more of the acquired images as the additional data for the acquired images. The processor may be a dedicated processor for performing in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. The memory 126 may be comprised of one or more solid-state memories, one or more optical memories, or any other combinations of known memory devices. The camera 120 may capture one or more images at the time of image acquisition. Accordingly, the camera may be a motion picture camera, such as a camcorder. Additionally, other self-generated content may also be provided with the additional data in accordance with the present invention. Other self-generated content may also include audio content (e.g., sound recordings). Accordingly, the term camera, as utilized herein, should be understood to encompass other devices for acquiring self-generated content. The devices embodied in FIG. 1 may actually be one or more separate devices. For example, the processor 122 GPS receiver 124, data input 110, memory 126, etc. may be embodied in a single device. In this or another embodiment, timeframe data and/or reference location data and the time of image acquisition and/or location of image acquisition may be acquired from a single device having a timing portion and/or a positioning portion.

Further, the term GPS receiver, such as GPS receiver 124, is intended to incorporate other devices and systems known that can determine a current position. For example, other devices may include a cellular transmitter within a cellular telephone network. The network may determine the position of the cellular transmitter and thereafter, transmit this location data to the camera 120. Accordingly, the location data may not need be determined by the camera 120, but may be determined external to the camera. In fact, the location data may be determined external to the camera and may be maintained external to the camera. In this embodiment, or other embodiments, such as those discussed above, the additional data may be determined external to the camera 120. The additional data may be transmitted to the camera 120 for storage in a memory, such as memory 126, or an external memory. In an embodiment wherein an external memory is utilized, the image data may thereafter be stored in the external memory together with the additional data.

Numerous alternate embodiments may be devised by those having ordinary skill in the art without departing from the spirit and scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., discrete electronic circuitry), software portions (e.g., computer programming), or any combination thereof;

f) any of the disclosed devices or portions thereof may be combined together or separated into further portions unless specifically stated otherwise; and

g) no specific sequence of acts is intended to be required unless specifically indicated.

1. A content acquiring device comprising:
a content input configured for acquiring content and at least one of a time of acquiring the content and a location of acquiring the content; and
a processor operatively coupled to the content input and the data input, wherein the processor is configured to determine additional data from a relation between at least one of the time of acquiring the content and the location of acquiring the content, and at least one of timeframe data and reference location data.

2. The content acquiring device of claim 1, wherein the content acquiring device is an imaging camera.

3. The content acquiring device of claim 1, comprising a global positioning system receiver (GPS) wherein the GPS is configured to provide the processor with the location of acquiring the content.

4. The content acquiring device of claim 1, wherein the content acquiring device is configured to receive both the timeframe data and the reference location data and wherein the timeframe data is a start and an end of a time interval and the reference location data is a location of the content acquiring device at the start and the end of the time interval.

5. The content acquiring device of claim 1, wherein the content acquiring device comprises a memory, wherein the memory is configured to store the acquired content and the determined additional data.

6. The content acquiring device of claim 1, comprising an audio input configured to receive at least one of the timeframe data and the reference location data.

7. The content acquiring device of claim 6, wherein the processor is configured to receive audio data from the audio input and to convert the audio input to at least one of the timeframe data and the reference location data.

8. The content acquiring device of claim 1, wherein at least one of the timeframe data and the reference location data is received from a network connection.

9. The content acquiring device of claim 8, wherein the network connection is configured to receive the least one of the timeframe data and reference location data from an external content storage device.

10. A method of acquiring self-generated content, the method comprising the acts of: acquiring content;
acquiring at least one of a time of acquiring the content and a location of acquiring the content;
receiving at least one of timeframe data and reference location data; and determining additional data from a relation between at least one of the time of acquiring the content and the location of acquiring the content, and at least one of the timeframe data and the reference location data.

11. The method of claim 10, wherein the acquired content is imaging content.

12. The method of claim 10, wherein both the timeframe data and the reference location data is acquired.

13. The method of claim 12, wherein the timeframe data is a start and an end of a time interval.

14. The method of claim 12, wherein the reference location data is a location of the content acquiring device at the start and the end of the time interval.

15. The method of claim 10, further comprising the acts of:
receiving audio input; and
converting the audio input to at least one of the timeframe data and the reference location data.

16. A content acquiring device comprising:
a content input configured for acquiring content and at least one of a time of acquiring the content and a location of acquiring the content;
a data input configured to receive at least one of timeframe data and reference location data; and
a processor operatively coupled to the content input and the data input, wherein the processor is configured to determine additional data from a relation between at least one of the time of acquiring the content and the location of acquiring the content, and at least one of the timeframe data and the reference location data.

17. The content acquiring device of claim 16, wherein the content acquiring device is configured to receive both the timeframe data and the reference location data and wherein the timeframe data is a start and an end of a time interval and the reference location data is a location of the content acquiring device at the start and the end of the time interval.

18. The content acquiring device of claim 16, comprising a position determining system wherein the position determining system is configured to provide the processor with the location of acquiring the content.

19. The content acquiring device of claim 18, wherein the GPS is configured to provide the processor with the reference location data.
